(19) United States
(12) Patent Application Publication
(10) Pub. No.: US 2024/0369909 A1
(43) Pub. Date: Nov. 7, 2024

(54) OPTICAL MODULE

(71) Applicant: TDK TAIWAN CORP., Taoyuan City (TW)

(72) Inventors: Szu-Yung HSIEH, Taoyuan City (TW); Yi-Ho CHEN, Taoyuan City (TW); Chia-Che WU, Taoyuan City (TW); Ying-Jen WANG, Taoyuan City (TW)

(21) Appl. No.: 18/654,988

(22) Filed: May 3, 2024

Related U.S. Application Data
(60) Provisional application No. 63/464,376, filed on May 5, 2023.

(51) Int. Cl. G03B 9/06

(52) U.S. Cl. CPC G03B 9/06

(57) ABSTRACT

An optical module is provided, including a movable part, a fixed part, a first driving assembly, and a first circuit assembly. The movable part is for connecting a first optical element. The movable part may move relative to the fixed part. The first driving assembly is for driving the movable part to move relative to the fixed part, and the first circuit assembly is for electrically connecting the first driving assembly.

### CROSS REFERENCE TO RELATED APPLICATIONS

This application claims the benefit of U.S. Provisional Application No. 63/464,376, filed May 5, 2023, the entirety of which is incorporated by reference herein.

### BACKGROUND OF THE INVENTION

### Field of the Invention

The present invention relates to an optical module, and, in particular, to an optical module that may drive optical elements to move in four dimensions.

### Description of the Related Art

With the development of science and technology, many electronic devices (such as notebook computers, smart phones and digital cameras) now have the function of taking pictures and recording videos. The use of these electronic devices is becoming more and more common. In addition to developing more stable devices with better optical quality, newer models also have convenient and thin designs that provide users with more choice.

In view of this, there is a need for an optical element that allows the optical photography focal length to be adjusted to adapt to the different external photography needs. At the same time, operational errors caused by interference with magnetic elements during operation may be reduced, stabilizing the internal structure, and providing more stability and better optical quality.

### BRIEF SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate parts of the entire specification of this disclosure, any or all drawings, and each claim.

According to certain aspects of the present disclosure, an optical module is provided. The optical module includes a movable part, a fixed part, a first driving assembly, and a first circuit assembly. The movable part is for connecting a first optical element. The movable part is movable relative to the fixed part. The first driving assembly is for driving the movable part to move relative to the fixed part. The first circuit assembly is for electrically connecting the first driving assembly.

According to an embodiment of the present invention, the fixed part includes an outer frame and a base. The outer frame has a top surface and a sidewall. An extension direction of the top surface is perpendicular to a main axis of the fixed part. An accommodating space is formed by the base and the outer frame, and the first optical element is not located in the accommodating space. The sidewall has a first surface and a second surface. A first output part of the first circuit assembly is disposed on the first surface. The second surface faces the accommodating space. The first surface and the second surface face opposite directions.

According to an embodiment of the present invention, the first driving assembly is connected to an external circuit through the first circuit assembly, and the first circuit assembly and the first output part are not disposed in the accommodating space.

According to an embodiment of the present invention, the optical module further includes a second circuit assembly for connecting to the external circuit. The second circuit assembly is electrically independent from the first circuit assembly, and the second circuit assembly is at least partially located in the accommodating space. When viewed along an extension direction of the sidewall, the first output part and the second output part of the second circuit assembly are located on two sides of the sidewall. The first surface faces the second output part, and the second surface faces the first output part.

According to an embodiment of the present invention, the optical module further includes a carrying assembly and a stopper assembly. The carrying assembly is movable relative to the fixed part to carry a second optical element. The carrying assembly is at least partially located in the accommodating space. When the carrying assembly moves, the carrying assembly drives the movable part to move. The stopper assembly is located in the accommodating space to limit the movement of the movable part relative to the fixed part within a range of motion, and to limit the movement of the carrying assembly relative to the fixed part.

According to an embodiment of the present invention, the optical module further includes a second driving assembly, electrically connected to the second circuit assembly and for driving the carrying assembly to move relative to the fixed part.

According to an embodiment of the present invention, the optical module further includes a frame and a guiding assembly. The frame is fixedly connected to the carrying assembly. The frame has a first frame surface facing an optical axis of the second optical element, and the optical axis passes through the accommodating space. The movable part may move relative to the frame through the guiding assembly. When viewed along the optical axis, the guiding assembly is at least partially located between the frame and the movable part.

According to an embodiment of the present invention, the first driving assembly is for driving the movable part to move in a first dimension relative to the frame. The second driving assembly is for driving the carrying assembly to move relative to the fixed part in a second dimension, a third dimension, and a fourth dimension. The first dimension is different from the second dimension. The first dimension, the second dimension, the third dimension, and the fourth dimension are all different from each other.

According to an embodiment of the present invention, when viewed along the optical axis, the guiding assembly does not overlap the first circuit assembly. The guiding assembly is not located between the movable part and the first circuit assembly. The frame has a second frame surface facing the guiding assembly, and the second frame surface and the first frame surface face in opposite directions.

According to an embodiment of the present invention, the first driving assembly includes a coil and a magnetic element that corresponds to the coil. When the carrying assembly moves, the coil and the magnetic element move relative to each other.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a perspective view of an optical module, first optical elements, and a second optical element, according to certain aspects of the present disclosure.

FIG. 2 is an exploded perspective view of the optical module, the first optical elements, and the second optical element, according to certain aspects of the present disclosure.

FIG. 3 is a block diagram of the first driving assembly, the second driving assembly, the first circuit assembly, and the second circuit assembly of the optical module, according to certain aspects of the present disclosure.

FIG. 4 is a cross-sectional view along line A-A of FIG. 1 of the optical module, the first optical elements, and the second optical element, according to certain aspects of the present disclosure, wherein the second optical element is located at a first extreme position.

FIG. 5 is a bottom view of the optical module, according to certain aspects of the present disclosure.

FIG. 6 is a cross-sectional view along line B-B of FIG. 1 of the optical module, according to certain aspects of the present disclosure.

FIG. 7 is a top view of the optical module, the first optical elements, and the second optical element, according to certain aspects of the present disclosure, wherein the first optical element is at a first position.

FIG. 8 is a top view of the optical module, the first optical elements, and the second optical element, according to certain aspects of the present disclosure, wherein the first optical element is at a second position.

FIG. 9 is a cross-sectional view along line A-A of FIG. 1 of the optical module, the first optical elements, and the second optical element, according to certain aspects of the present disclosure, wherein the second optical element is located at a second extreme position.

### DETAILED DESCRIPTION OF THE INVENTION

Various embodiments are described with reference to the accompanying drawings, wherein like reference characters are used to designate similar or equivalent elements throughout. The drawings are not to scale and are provided solely to illustrate features and characteristics of the present disclosure. It is understood that many specific details, relationships, and methods are set forth to provide a comprehensive understanding. However, one of ordinary skill in the art will readily recognize that various embodiments may be practiced without one or more of the specific details or in other ways. In some instances, well-known structures or operations are not shown in detail for illustrative purposes. Various embodiments are not limited to the order in which actions or events are displayed, as some actions may occur in a different order and/or concurrently with other actions or events. Furthermore, not all actions or events shown may be required to implement certain aspects and characteristics of the present disclosure.

For the purposes of this embodiment, unless expressly stated otherwise, the singular includes the plural and vice versa. The term “including” means, “including without limitation”. In addition, similar words such as “about (bout, almost, substantially, approximately)” and similar words may here mean, for example, “at”, “near, nearly at”, “at 3% “Within 3-5% of”, “within acceptable manufacturing tolerances” or any logical combination thereof. Additionally, the terms “vertical” or “horizontal” are intended to additionally include “within 3-5%” of the vertical or horizontal direction, respectively. In addition, directional terms such as “top,” “bottom,” “left,” “right,” “above,” and “below” are intended to relate to the equivalent directions depicted in the reference illustration; from the reference object or component Understood in context, such as from the usual position of the object or element; or such other description.

It will be understood that, although the terms “first”, “second”, etc. may be used herein to describe various elements, layers and/or parts, these elements, layers and/or parts should not be referred to as such. The terms are limited and are only used to distinguish between different components, layers and/or sections. Thus, a first element, layer and/or section discussed below could be termed a second element, layer and/or section without departing from the teachings of some embodiments of the present disclosure. In addition, for the sake of simplicity, terms such as “first” and “second” may not be used to distinguish different components in the specification. Without departing from the scope defined in the appended patent application, the first element and/or the second element described in the patent application may be interpreted as any element consistent with the description in the specification.

The following description is made for the purpose of illustrating the general principles of the invention and should not be taken in a limiting sense. The scope of the invention is best determined by reference to the appended claims.

The present disclosure relates to an optical module that drives a movable part to drive optical elements, thereby adjusting the photographic imaging of the optical system to adapt to different photographic needs.

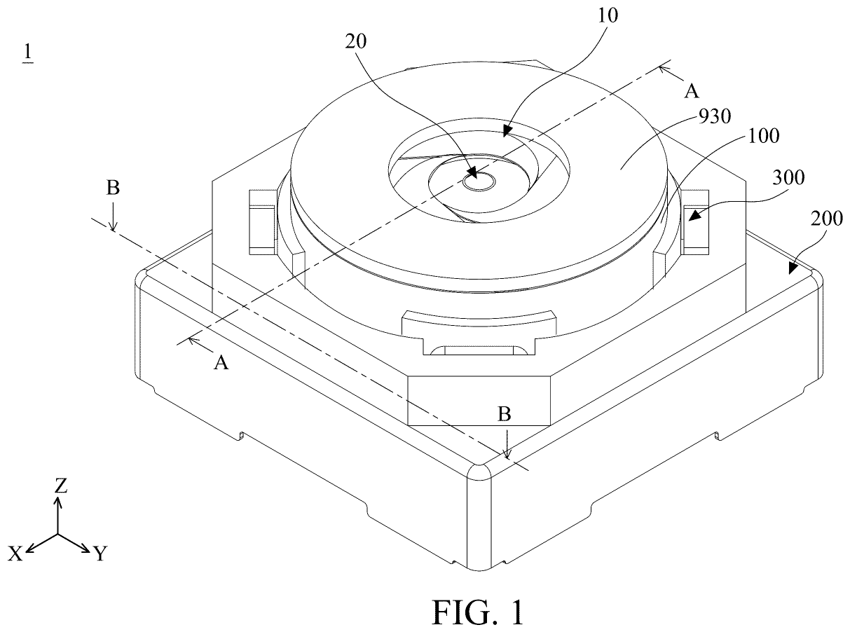

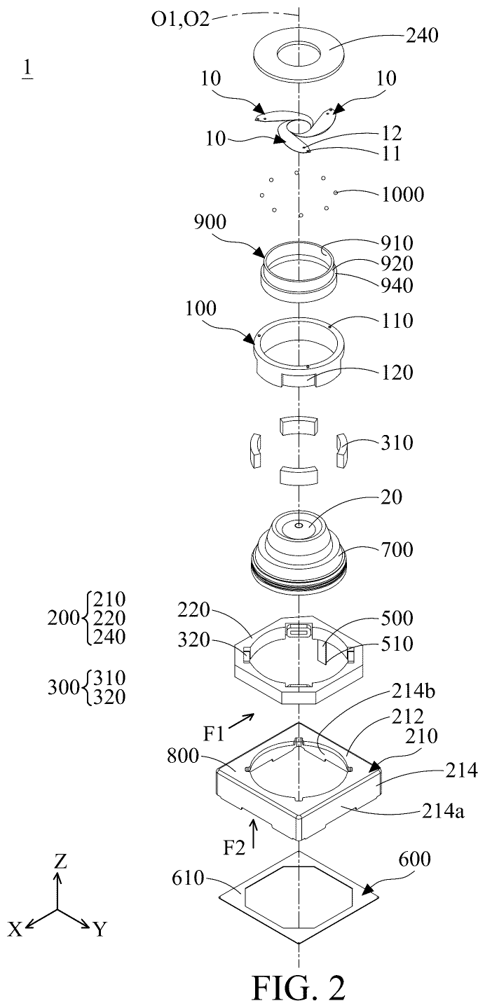

First, please refer to FIG. 1 and FIG. 2. FIG. 1 is a perspective view of an optical module 1, first optical elements 10, and a second optical element 20, according to certain aspects of the present disclosure. FIG. 2 is an exploded perspective view of the optical module 1, the first optical elements 10, and the second optical element 20, according to certain aspects of the present disclosure.

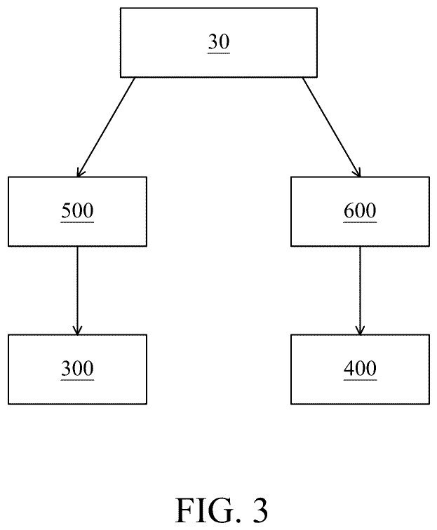

The optical module 1 includes a movable part 100, a fixed part 200, a first driving assembly 300, a second driving assembly 400 (shown in FIG. 3), a first circuit assembly 500, a second circuit assembly 600, a carrying assembly 700, a stopper assembly 800, a frame 900, and a guiding assembly 1000.

The movable part 100 may be connected to a plurality of first optical elements 10 and may move relative to the fixed part 200. The first driving assembly 300 drives the movable part 100 and the first optical elements 10 to move relative to the fixed part 200. The second driving assembly 400 drives the movable part 100 and the carrying assembly 700 to move relative to the fixed part 200.

Next, please refer to FIGS. 2 and 3 together. FIG. 3 is a block diagram of the first driving assembly 300, the second driving assembly 400, the first circuit assembly 500, the second circuit assembly 600 and an external circuit 30 connected to the optical module 1, according to certain aspects of the present disclosure. The first driving assembly 300 is connected to an external circuit 30 through the first circuit assembly 500. The second driving assembly 400 is connected to the external circuit 30 through the second circuit assembly 600. The external circuit 30 may be, for example, an integrated circuit of a photosensitive element module.

Next, please refer to FIG. 2. The carrying assembly 700 is movable relative to the fixed part 200 and carries the second optical element 20. The stopper assembly 800 limits the movement of the movable part 100 relative to the fixed part 200 within a range of motion, and limits the movement of the carrying assembly 700 relative to the fixed part 200. The frame 900 fixedly connects the carrier assembly 700.

The first optical elements 10 may be, for example, aperture blades. A plurality of aperture blades form an aperture. By adjusting the position of the first optical elements 10, the size of the aperture may be adjusted, thereby adjusting the amount of light entering the optical module 1.

The second optical element 20 may be, for example, a lens or a photosensitive element, and it is carried by the carrying assembly 700 to move to adjust the imaging, etc.

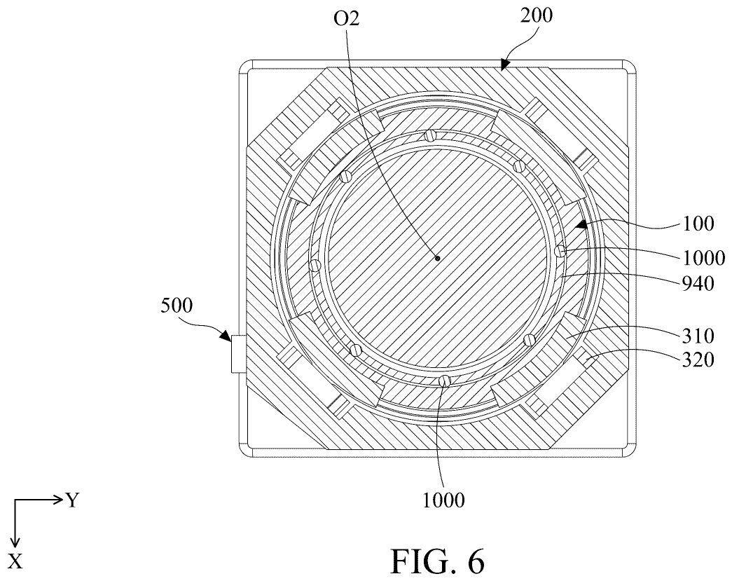

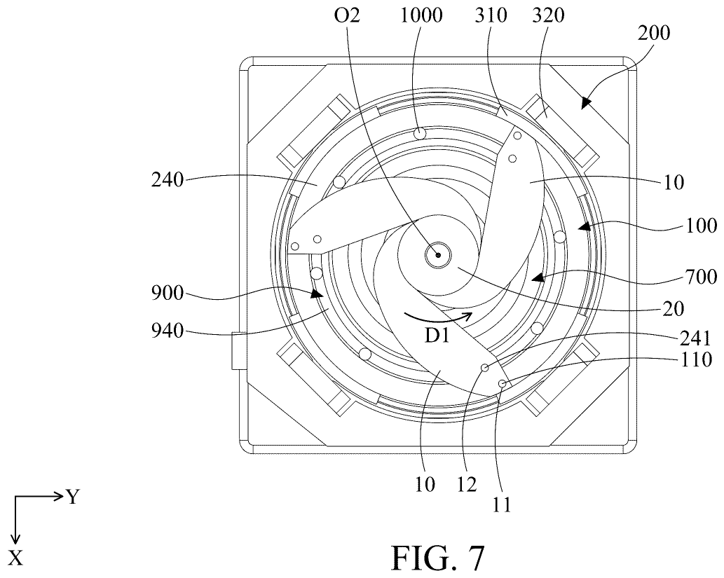

The movable part 100 has a plurality of pillars 110 and a plurality of recessed parts 120. The pillars 110 may pass through the plurality of holes 11 of the first optical elements 10 to drive the first optical elements 10 to move, as explained below with respect to FIG. 6 and FIG. 7. The movable part 100 rests on the carrying assembly 700.

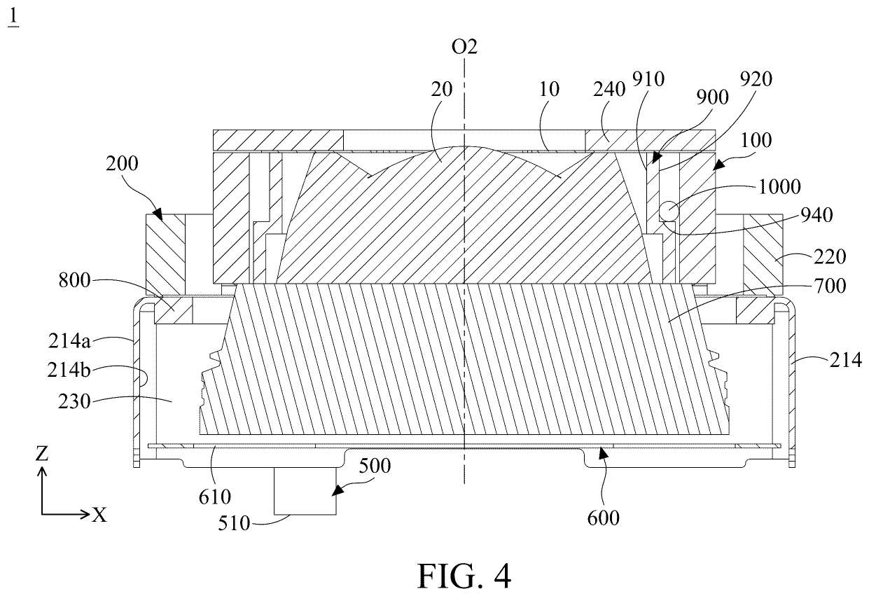

The fixed part 200 includes an outer frame 210, a base 220, and a top cover 240. The fixed part 200 has a main axis O1. The outer frame 210 has a top surface 212 and a sidewall 214. An extension direction F1 of the top surface 212 (i.e., a direction parallel to the top surface 212) is perpendicular to the main axis O1 of the fixed part 200. The outer frame 210 is fixedly disposed on the base 220. The base 220 and the outer frame 210 form an accommodating space 230 (FIG. 4).

The first optical elements 10 are not located in the accommodating space 230, but they are located outside the accommodating space 230. The second circuit assembly 600 and the carrying assembly 700 are at least partially located in the accommodating space 230. The stopper assembly 800 is located in the accommodating space 230.

The sidewall 214 has a first surface 214a and a second surface 214b. The second surface 214b faces the accommodating space 230 and also faces the main axis O1. The first surface 214a and the second surface 214b face opposite directions. The first surface 214a faces away from the accommodating space 230 and the main axis O1.

The first driving assembly 300 includes a magnetic element 310 and a coil 320, driving the movable part 100 and the first optical elements 10 to move relative to the fixed part 200, as explained below with respect to FIG. 6 and FIG. 7. The magnetic element 310 corresponds to the coil 320.

In this embodiment, the magnetic element 310 is disposed in the recess 120 of the movable part 100 to drive the movement of the movable part 100, and the coil 320 is disposed on the outer frame 210. However, in other embodiments, it may also have different configurations.

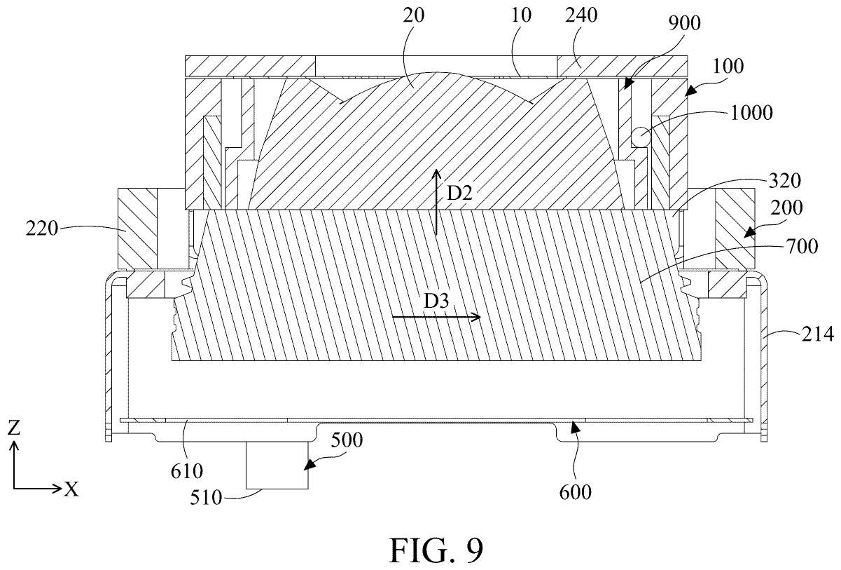

The second driving assembly 400 is partially disposed on the carrying assembly 700 and may be a voice coil motor, including a magnetic element and a coil. The magnetic element corresponds to the coil and drives the movable parts 100, the carrying assembly 700, and the second optical element 20 to move relative to the fixed part 200, as will be explained below with respect to FIG. 4 and FIG. 9.

In this embodiment, the magnetic element of the second driving assembly 400 (shown in FIG. 3) is disposed on the carrying assembly 700 to drive the movement of the carrying assembly 700, and the coil may be disposed on the outer frame 210. However, in other embodiments, it may also have different configurations.

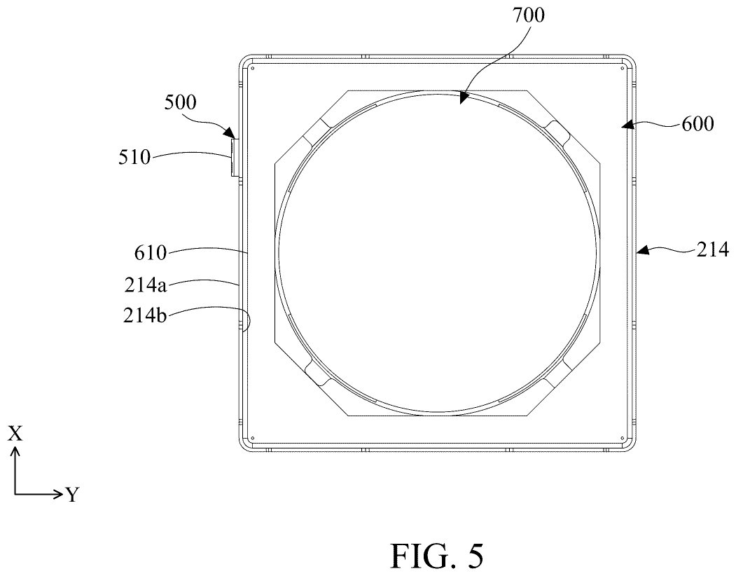

Next, please refer to FIG. 3-FIG. 5 together. FIG. 4 is a cross-sectional view of the optical module 1 and the first optical elements 10 and the second optical elements 20 along line A-A in FIG. 1, according to certain aspects of the present disclosure, wherein the second optical element 20 is located in a first extreme position. FIG. 5 is a bottom view of the optical module 1, according to certain aspects of the present disclosure.

The first circuit assembly 500 is for electrically connecting the first driving assembly 300 and has a first output part 510. With reference to FIG. 4 and FIG. 5, the first output part 510 extends from the first surface 214a. The first circuit assembly 500 is not disposed in the accommodating space 230, that is, the first output part 510 is not disposed in the accommodating space 230. The first driving assembly 300 is connected to the external circuit 30 via the first circuit assembly 500.

The second circuit assembly 600 is at least partially located in the accommodating space 230. The second circuit assembly 600 has a second output part 610. The second circuit assembly 600 is for electrically connecting the second driving assembly 400. The second circuit assembly 600 is electrically independent from the first circuit assembly 500.

When viewed along an extension direction F2 of the side wall 214 (see FIG. 2, that is, the direction parallel to the sidewall 214), the first output part portion 510 and the second output part 610 are respectively located on both sides of the side wall 214. The first surface 214a faces the first output part 510, and the second surface 214b faces the second output part 610.

Next, please continue to refer to FIG. 2. The carrying assembly 700 is at least partially located in the accommodating space 230. The carrying assembly 700 connects the second optical element 20. When the carrying assembly 700 is driven by the second driving assembly 400 to move, the carrying assembly 700 drives the movement of the movable part 100, the frame 900, the first optical elements 10, and the second optical element 20.

Next, please continue to refer to FIG. 4. The stopper assembly 800 is located in the accommodating space 230 to limit the movement of the movable part 100 relative to the fixed part 200 within a range of motion, and to limit the movement of the carrying assembly 700 relative to the fixed part 200.

The frame 900 is fixedly connected to the carrying assembly 700. The frame 900 has a first frame surface 910, a second frame surface 920, and a guiding groove 940. The first frame surface 910 faces an optical axis O2 of the second optical element 20, and the optical axis O2 passes through the accommodating space 230. The second frame surface 920 faces the guiding assembly 1000, and the second frame surface 920 and the first frame surface 910 face opposite directions.

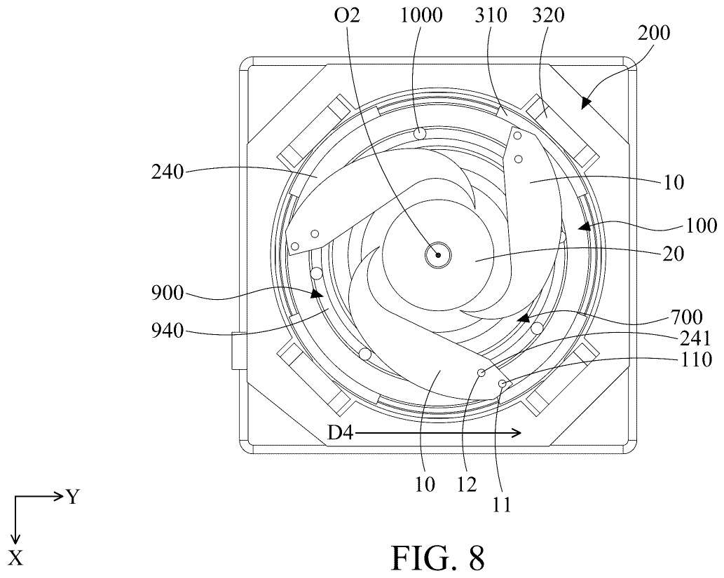

The top cover 240 of the fixed part 200 has a plurality of pillars 241 (shown in FIG. 7 and FIG. 8) on a surface facing the optical element 10, the plurality of pillars 241 may pass through the plurality of holes 12 of the first optical elements 10. In some embodiments, the top cover 240 may be fixedly connected to the frame 900, and the first optical element 10 may be movably disposed between the top cover 240 and the frame 900, but is not limited thereto.

The pillars 110 of the movable part 100 pass through the holes 11 of the first optical elements 10, and the pillars 241 of the top cover 240 pass through the holes 12 of the first optical elements 10. When the first driving assembly 300 drives the movable part 100, the top cover 240 is not driven by the first driving assembly 300 and does not move, causing relative movement between the first optical elements 10, the movable part 100, and the top cover 240. The positional movement of the first optical elements 10 changes the size of the aperture formed by the first optical elements 10, thereby changing the amount of light entering the optical module 1, as explained below with respect to FIG. 7 and FIG. 8.

The guiding assembly 1000 is movably disposed between the frame 900 and the movable part 100, more specifically, disposed in the guiding groove 940 of the frame 900. When the movable part 100 moves, the guiding assembly 1000 rolls in the guiding groove 940, so the movable part 100 may slidably move relative to the frame 900 via the guiding assembly 1000.

Please refer to FIG. 6 next. FIG. 6 is a cross-sectional view of the optical module 1 along line B-B of FIG. 1, according to certain aspects of the present disclosure. When viewed along the optical axis O2, the guiding assembly 1000 is at least partially located between the frame 900 and the movable part 100. When viewed along the optical axis O2, the guiding assembly 1000 does not overlap the first circuit assembly 500. The guiding assembly 1000 is not located between the movable part 100 and the first circuit assembly 500.

Next, please refer to FIG. 7 and FIG. 8 together. FIG. 7 is a top view of the optical module 1 and the first optical elements 10 and the second optical element 20, according to certain aspects of the present disclosure, wherein the first optical elements 10 are located in a first position. FIG. 8 is a top view of the optical module 1 and the first optical elements 10 and the second optical element 20, according to certain aspects of the present disclosure, where the first optical elements 10 are located in a second position.

Due to the electromagnetic driving force generated between the magnetic element 310 and the coil 320, the magnetic element 310 moves relative to the coil 320, and the magnetic element 310 drives the movement of the movable part 100. Therefore, the first driving assembly 300 may drive the movable part 100 to move relative to the fixed part 200 and the frame 900 in a first dimension D1. Wherein the first dimension D1 rotates, with the optical axis O2 as the center of the circle.

When the movable part 100 moves in the first dimension D1, the pillars 110 drive the holes 11 of the first optical elements 10, and the holes 12 of the first optical elements 10 are fixed by the pillars 241 of the top cover 240, causing the position of the first optical elements 10 to move from the first position shown in FIG. 7 to the second position shown in FIG. 8. The movement range of the movable part 100 is from the first position shown in FIG. 7 to the second position shown in FIG. 8. The positional movement of the first optical elements 10 changes the size of the aperture formed by the first optical elements 10 to achieve the purpose of changing the amount of light entering the optical module 1. In addition, the shape and number of the first optical elements 10, the pillars 241 of the top cover 240, the holes 12 of the first optical elements 10, the pillars 110 of the movable part 100, and the holes 11 of the first optical elements 10 may be determined according to actual aperture size needs, but it is not limited to this.

Next, please refer to FIG. 4 and FIG. 9 together. FIG. 9 is a cross-sectional view of the optical module 1 and the first optical elements 10 and the second optical element 20 along line A-A in FIG. 1, according to certain aspects of the present disclosure, wherein the second optical element 20 is located at a second extreme position.

Due to the electromagnetic driving force generated by the second driving assembly 400, the magnetic element moves relative to the coil, and the magnetic element drives the movement of the carrying assembly 700. Therefore, the second driving assembly 400 may drive the carrying assembly 700 to move along a second dimension D2, a third dimension D3 (shown in FIG. 9), and a fourth dimension D4 (shown in FIG. 8) relative to the fixed part 200. Wherein the second dimension D2 is the movement along the Z-axis, the third dimension D3 is the movement along the X-axis, and the fourth dimension D4 is the movement along the Y-axis.

When the carrying assembly 700 moves relative to the fixed part 200, the carrying assembly 700 drives the second optical element 20. Since the movable part 100 and the frame 900 rest on the carrying assembly 700, the movable part 100, the frame 900 and the optical element 10 are also driven by the carrying assembly 700 to move together. The carrying assembly 700 and the second optical element 20 move from the first extreme position shown in FIG. 4 to the second extreme position shown in FIG. 9. The position movement of the second optical element 20 may change the focal length, etc., to achieve the purpose of making the image clear.

The first dimension D1 is different from the second dimension D2. The first dimension D1, the second dimension D2, the third dimension D3, and the fourth dimension D4 are all different from each other. For example, the movement in the first dimension D1 may be used to adjust the aperture size, the movement in the second dimension D2 may achieve the effect of adjusting the focus (Auto Focus, AF), and the movement in the third dimension D3 and the movement in the fourth dimension D4 may achieve optical image stabilization (OIS), but not limited to this.

When the carrying assembly 700 moves, the coil 320 and the magnetic element 310 move relative to each other.

The first driving assembly 300 is powered by the first circuit assembly 500, and is electrically connected to the external circuit 30 through the first output part 510 (shown in FIG. 3). The second driving assembly 400 is powered by the second circuit assembly 600 and is electrically connected to the external circuit 30 through the second output part 610. After being connected to the external circuit 30, the external circuit 30 integrates the circuits of the first circuit assembly 500 and the second circuit assembly 600.

In the optical module 1, the second circuit assembly 600 and the first circuit assembly 500 are electrically independent. By making the first circuit assembly 500 and the second circuit assembly 600 electrically independent, the first driving assembly 300 and the second driving assembly 400, the movable part 100 and the carrying assembly 700, as well as the aperture adjustment and lens focus adjustment are separated, thereby reducing circuit design complexity, the module may be miniaturized.

To sum up, the optical module of the embodiment of the present disclosure may make the movable part move smoothly relative to the fixed part, and one driving assembly may drive the movable part to change the size of the aperture opening formed by the first optical element, thereby adjusting the amount of incident light. Another driving assembly drives the carrying assembly to change the position of the second optical element, thereby adjusting the focal length of the lens and achieving the effect of optical image stabilization.

Unless otherwise defined, all terms (including technical and scientific terms) used herein have the same meaning as commonly understood by one of ordinary skill in the art to which this disclosure belongs. It is understood that these terms, such as terms defined in commonly used dictionaries, should be interpreted to have a meaning consistent with the relevant technology and the background or context of the present disclosure, and should not be interpreted in an idealized or overly formal manner. Interpretation, unless specifically defined herein.

In summary, the present invention provides an optical element, which includes a movable part, a fixed part, a driving assembly, a guiding assembly, and an electronic assembly. The movement of the driving assembly drives the movable part to move relative to the fixed part. With this, the position of the optical element may be adjusted to adapt to different external photography needs. At the same time, its magnetically permeable top plate opening structure may also effectively reduce operational errors caused by interference with magnetic elements during operation, stabilize the internal structure, and provide more stable and better optical quality.

Although embodiments of the invention have been shown and described with respect to one or more embodiments, equivalents and modifications will occur to those of ordinary skill in the art upon reading and understanding this specification and the accompanying drawings. Additionally, while particular features of the invention may have been invented with respect to only one embodiment of several embodiments, multiple other feature combination features may be combined with one or more of the other embodiments as may be required and advantageous for any given or particular application.

Although various embodiments of the present invention have been described above, it should be understood that they are presented by way of example only and not limitation. Various changes may be made in accordance with the embodiments invented herein without departing from the spirit or scope of the invention. Accordingly, the breadth and scope of the present invention should not be limited by any of the above-described embodiments. Rather, the scope of the invention should be defined in accordance with the following claims and their equivalents.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or patent application scope are intended to be similar to “comprising” is included.

What is claimed is:

1. An optical module, comprising:
a movable part, for connecting a first optical element;
a fixed part, wherein the movable part is movable relative to the fixed part;
a first driving assembly, for driving the movable part to move relative to the fixed part; and
a first circuit assembly, for electrically connecting the first driving assembly.

2. The optical module as claimed in claim 1, wherein the fixed part includes:
an outer frame, including a top surface and a sidewall, wherein an extension direction of the top surface is perpendicular to a main axis of the fixed part;
a base, wherein an accommodating space is formed by the base and the outer frame, and the first optical element is not located in the accommodating space.

3. The optical module as claimed in claim 2, wherein the sidewall includes:
a first surface, wherein a first output part of the first circuit assembly is disposed on the first surface; and
a second surface, facing the accommodating space, wherein the first surface and the second surface face opposite directions.

4. The optical module as claimed in claim 2, wherein the first circuit assembly and the first output part are not disposed in the accommodating space.

5. The optical module as claimed in claim 2, wherein the first driving assembly is connected to an external circuit through the first circuit assembly.

6. The optical module as claimed in claim 5, further comprising a second circuit assembly for connecting to the external circuit, wherein the second circuit assembly is electrically independent from the first circuit assembly, and the second circuit assembly is at least partially located in the accommodating space.

7. The optical module as claimed in claim 6, wherein when viewed along an extension direction of the sidewall, the first output part of the first circuit assembly and a second output part of the second circuit assembly are respectively located on two sides of the sidewall.

8. The optical module as claimed in claim 7, wherein the first surface faces the first output part, and the second surface faces the second output part.

9. The optical module as claimed in claim 8, further comprising a carrying assembly, movable relative to the fixed part, for carrying a second optical element, wherein the carrying assembly is at least partially located in the accommodating space, wherein when the carrying assembly moves, the carrying assembly drives the movable part to move.

10. The optical module as claimed in claim 9, wherein the first driving assembly includes a coil and a magnetic element corresponding to the coil, wherein when the carrying assembly moves, the coil and the magnetic element move relative to each other.

11. The optical module as claimed in claim 10, further comprising a stopper assembly, located in the accommodating space, limiting the movement of the movable part relative to the fixed part within a range of motion, and the movement of the carrying assembly relative to the fixed part.

12. The optical module as claimed in claim 10, further comprising a second driving assembly electrically connected to the second circuit assembly, for driving the carrying assembly to move relative to the fixed part.

13. The optical module as claimed in claim 12, further comprising:
a frame, fixedly connected to the carrying assembly, wherein the frame has a first frame surface facing an optical axis of the second optical element; and
a guiding assembly, through which the movable part moves relative to the frame.

14. The optical module as claimed in claim 13, wherein when viewed along the optical axis, the guiding assembly does not overlap the first circuit assembly, and the guiding assembly is not located between the movable part and the first circuit assembly.

15. The optical module as claimed in claim 13, wherein the frame has a second frame surface facing the guiding assembly, and the second frame surface faces the opposite direction from the first frame surface.

16. The optical module as claimed in claim 13, wherein the optical axis passes through the accommodating space, and when viewed along the optical axis, the guiding assembly is at least partially located between the frame and the movable part.

17. The optical module as claimed in claim 13, wherein the first driving assembly is for driving the movable part to move in a first dimension relative to the frame.

18. The optical module as claimed in claim 17, wherein the second driving assembly is for driving the carrying assembly to move relative to the fixed part in a second dimension, a third dimension, and a fourth dimension.

19. The optical module as claimed in claim 18, wherein the first dimension is different from the second dimension.

20. The optical module as claimed in claim 18, wherein the first dimension, the second dimension, the third dimension, and the fourth dimension are all different from each other.
